(19) United States
(12) Patent Application Publication
(10) Pub. No.: US 2026/0104774 A1
(43) Pub. Date: Apr. 16, 2026

(54) DISPLAY APPARATUS, DISPLAY DRIVING DEVICE AND OPERATING METHOD THEREOF

(71) Applicant: Novatek Microelectronics Corp., Hsinchu (TW)

(72) Inventors: Jen-Cheng Hsiao, Hsinchu City (TW); Jing-Hsien Fu, Taoyuan City (TW)

(73) Assignee: Novatek Microelectronics Corp., Hsinchu (TW)

(21) Appl. No.: 18/914,282

(22) Filed: Oct. 14, 2024

(51) Int. Cl. G06F 3/041

(52) U.S. Cl. CPC G06F 3/04184; G06F 3/04166; G09G 2300/0408; G09G 2310/0267; G09G 2310/0278; G09G 2310/06; G09G 2310/08; G09G 2330/023; G09G 2354/00

(57) ABSTRACT

The disclosure provides a display apparatus, a display driving device, and an operating method thereof. The display apparatus includes a display panel, a touch driving device, and the display driving device. The touch driving device drives the display panel to detect touch events. The display driving device generates multiple gate clocks to a gate line circuit of the display panel. The display driving device generates the gate clocks in a first scanning sub-period of a same frame period with a charge sharing function disabled. The display driving device generates the gate clocks in a second scanning sub-period of the same frame period with the charge sharing function enabled.

### BACKGROUND

### Technical Field

The disclosure relates to an electronic device, and in particular to a display apparatus, a display driving device, and an operating method thereof.

### Description of Related Art

FIG. 1 is schematic diagram of the waveform of a gate clock without a charge sharing function during a full frame period. The horizontal axis of FIG. 1 represents time. A display driving device may generate a gate clock GCLK1 to a touch display panel. The display driving device performs a toggle operation on the gate clock GCLK1, which is to cause the gate clock GCLK1 to switch back and forth between a high gate voltage level VGH and a low gate voltage level VGL. As shown in FIG. 1, the display driving device pulls up the gate clock GCLK1 from the low gate voltage level VGL to the high gate voltage level VGH at time point t11, and pulls down the gate clock GCLK1 from the high gate voltage level VGH to the low gate voltage level VGL at time point t12. Due to a coupling effect that occurs in the touch display panel, a voltage transition of the gate clock GCLK1 may cause a noise in a touch detection operation of the touch display panel. For example, a touch noise NOISE_TP1 shown in FIG. 1 has a noise surge at each of the time points t11 and t12. Generally speaking, touch detection algorithms may filter out noise to a limited extent. For example, in the case of “the number of noise surges of the touch noise NOISE_TP1 within 14 μs (microseconds) is not more than 6”, the touch detection algorithm can successfully filter out the noise without affecting the accuracy of the touch detection.

Since the display driving device toggles the gate clock GCLK1 (the gate clock GCLK1 switches back and forth between the high gate voltage level VGH and the low gate voltage level VGL), the display driving device consumes a lot of power. The charge sharing function can effectively reduce the power consumption of the display driving device.

FIG. 2 is a schematic diagram of the waveform of the gate clock with the charge sharing function enabled during the full frame period. The horizontal axis of FIG. 2 represents time. When the charge sharing function is enabled, the display driving device pulls up the voltage level of the gate clock GCLK2 from the low gate voltage level VGL to a certain charge sharing level VCS (the charge sharing level VCS is between the high gate voltage level VGH and the low gate voltage level VGL) during a charge sharing period tc first, and then after the charge sharing period tc ends, the voltage level of the gate clock GCLK2 is pulled up from the charge sharing level VCS to the high gate voltage level VGH. In the same way, the display driving device pulls down the voltage level of the gate clock GCLK2 from the high gate voltage level VGH to the charge sharing level VCS during the charge sharing period te first, and then pulls down the voltage level of the gate clock GCLK2 from the charge sharing level VCS to the low gate voltage level VGL after the charge sharing period tc ends. Generally speaking, the display driving device consumes very little power in the process of transitioning the gate clock GCLK2 from the low gate voltage level VGL (or the high gate voltage level VGH) to the charge sharing level VCS. Therefore, the charge sharing function is a function that can effectively reduce power consumption.

As shown in FIG. 2, the display driving device pulls up the gate clock GCLK2 from the low gate voltage level VGL to the charge sharing level VCS at time point t21, and then pulls up the voltage level of the gate clock GCLK2 from the charge sharing level VCS to the high gate voltage level VGH at time point t22. The display driving device pulls down the gate clock GCLK2 from the high gate voltage level VGH to the charge sharing level VCS at time point t23, and then pulls down the voltage level of the gate clock GCLK2 from the charge sharing level VCS to the low gate voltage level VGL at time point t24. The voltage transition of the gate clock GCLK2 causes noise in the touch detection operation of the touch display panel. For example, a touch noise NOISE_TP2 shown in FIG. 2 has a noise surge at each of the time points t21, t22, t23 and t24. Compared with the touch noise NOISE_TP1 shown in FIG. 1, the touch noise NOISE_TP2 shown in FIG. 2 has denser (more) noise surges due to the enablement of the charge sharing function. The denser (more) noise surges may prevent the touch detection algorithm from successfully filtering out noise, thereby affecting the accuracy of touch detection.

It should be noted that the content of the “Description of Related Art” paragraph is used to help understand the disclosure. Some of the content (or all of the content) disclosed in the “Description of Related Art” paragraph may not be known by persons skilled in the art. The content disclosed in the “Description of Related Art” paragraph does not mean that the content has been known to persons skilled in the art before the application of the disclosure.

### SUMMARY

The disclosure provides a display apparatus, a display driving device, and an operating method thereof to avoid affecting the accuracy of touch detection.

In an embodiment of the disclosure, the display apparatus includes a display panel, a touch driving device, and a display driving device. The touch driving device is coupled to the display panel. The touch driving device drives the display panel to detect touch events. The display driving device is configured to drive the display panel. The display driving device generates multiple gate clocks to a gate line circuit of the display panel, and the gate line circuit scans multiple scan lines of the display panel based on the gate clocks. A same frame period includes a first scanning sub-period and a second scanning sub-period. The display driving device generates the gate clocks in the first scanning sub-period of the same frame period with a charge sharing function disabled. The display driving device generates the gate clocks in the second scanning sub-period of the same frame period with the charge sharing function enabled.

In an embodiment of the disclosure, the display driving device includes a timing controller, a source driver, and a gate clock generation circuit. The source driver is coupled to the timing controller. The source driver drives multiple data lines of the display panel based on the control of the timing controller. The gate clock generation circuit is coupled to the timing controller. The gate clock generation circuit generates the gate clocks to the gate line circuit of the display panel based on the control of the timing controller. The gate line circuit scans the scan lines of the display panel based on the gate clocks. The same frame period includes the first scanning sub-period and the second scanning sub-period. The gate clock generation circuit generates the gate clocks in the first scanning sub-period of the same frame period with the charge sharing function disabled. The gate clock generation circuit generates the gate clocks in the second scanning sub-period of the same frame period with the charge sharing function enabled.

In an embodiment of the disclosure, the operating method includes: driving the data lines of the display panel by the source driver of the display driving device; generating the gate clocks to the gate line circuit of the display panel by the gate clock generation circuit of the display driving device, in which the gate line circuit scans the scan lines of the display panel based on the gate clocks, the same frame period includes the first scanning sub-period and the second scanning sub-period, the gate clock generation circuit generates the gate clocks in the first scanning sub-period of the same frame period with the charge sharing function disabled, and the gate clock generation circuit generates the gate clocks in the second scanning sub-period of the same frame period with the charge sharing function enabled.

Based on the above, the gate clock generation circuit according to the embodiments of the disclosure disables and enables the charge sharing function in different scanning sub-periods of the same frame period to reduce noise surges of the touch noise. For example, based on the actual operation scenario, it is assumed that the gate clocks generated by the gate clock generation circuit include a first gate clock and a second gate clock, and the first gate clock and the second gate clock in the second scanning sub-period are mutually inverse. The so-called mutually inverse means that the voltage transition time points of the first gate clock and the second gate clock are approximately the same and the voltage transition directions of the first gate clock and the second gate clock are opposite. Since the first gate clock and the second gate clock are mutually inverse, the touch noise caused by the two may cancel each other out, so that the gate clock generation circuit may enable the charge sharing function during the second scanning sub-period to reduce the power consumption. It is assumed that the touch noises caused by the gate clocks do not cancel each other during the first scanning sub-period, so the gate clock generation circuit disables the charge sharing function during the first scanning sub-period to avoid affecting the accuracy of the touch detection.

To make the aforementioned more comprehensible, several embodiments accompanied with drawings are described in detail as follows.

### BRIEF DESCRIPTION OF THE DRAWINGS

FIG. 1 is schematic diagram of the waveform of a gate clock without a charge sharing function during a full frame period.

FIG. 2 is a schematic diagram of the waveform of the gate clock with the charge sharing function enabled during the full frame period.

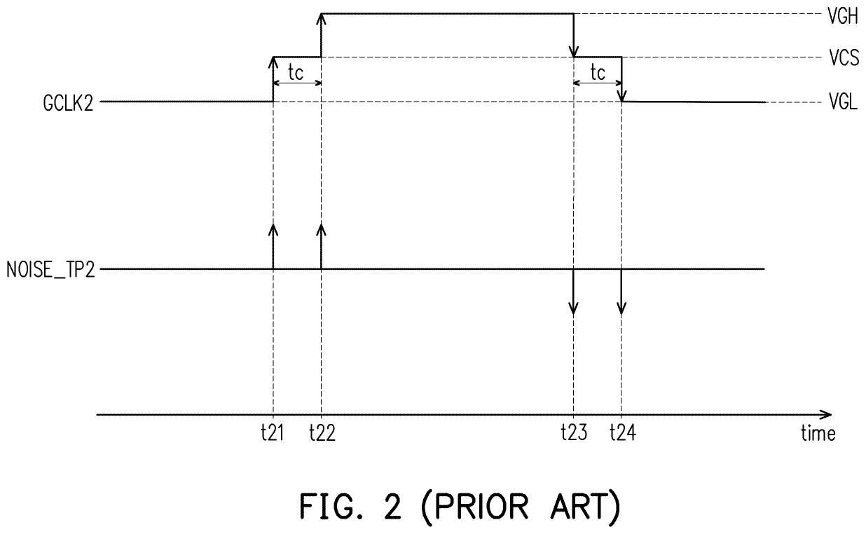

FIG. 3 is a schematic circuit block diagram of a display apparatus according to an embodiment of the disclosure.

FIG. 4 is a schematic diagram of the waveform of the gate clock with a charge sharing function enabled during a full frame period according to an embodiment of the disclosure.

FIG. 5 is a schematic flowchart of an operating method of a display driving device according to an embodiment of the disclosure.

FIG. 6 is a schematic diagram of the waveform of the gate clock when the charge sharing function is dynamically disabled/enabled in different scanning sub-periods of the same frame period according to an embodiment of the disclosure.

FIG. 7 is a circuit block diagram of a gate clock generation circuit according to an embodiment of the disclosure.

FIG. 8 is a schematic flowchart of an operating method of a display driving device according to another embodiment of the disclosure.

### DESCRIPTION OF THE EMBODIMENTS

A term “couple (or connected)” used in the full text of the disclosure (including the claims) refers to any direct and indirect connections. For example, if a first device is described to be coupled (or connected) to a second device, it is interpreted as that the first device is directly connected to the second device, or the first device is indirectly connected to the second device through other devices or connection means. The terms “first”, “second”, and the like as mentioned throughout the full text of the disclosure (including the claims) are used to name the elements or to distinguish between different embodiments or scopes, rather than setting an upper or lower limit on the number of the elements or the order of the elements. Moreover, wherever possible, components/members/steps using the same referential numbers in the drawings and description refer to the same or like parts. Components/members/steps using the same referential numbers or using the same terms in different embodiments may cross-refer related descriptions.

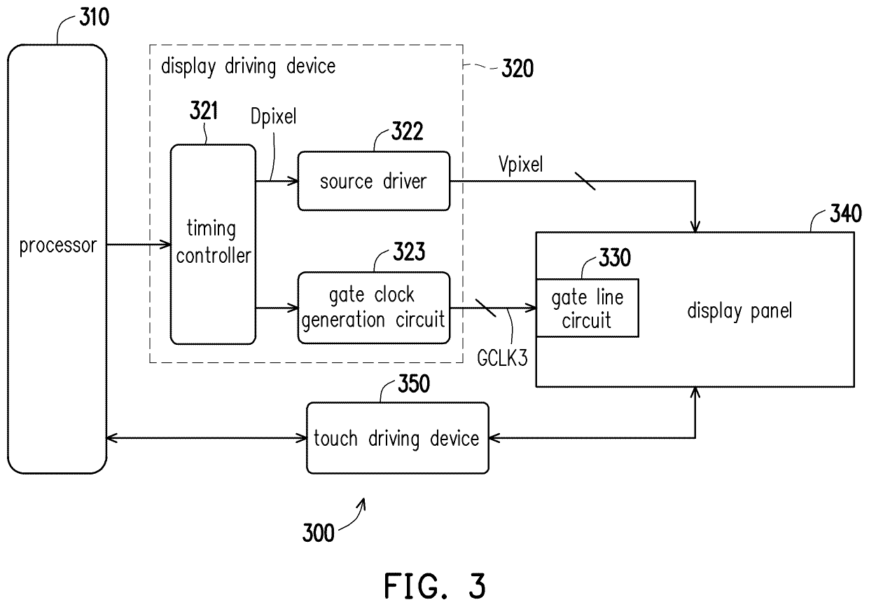

FIG. 3 is a schematic circuit block diagram of a display apparatus 300 according to an embodiment of the disclosure. The display apparatus 300 shown in FIG. 3 includes a processor 310, a display driving device 320, a gate line circuit 330, a display panel 340, and a touch driving device 350. Based on actual design and application, the processor 310 may be an application processor (AP), a central processing unit (CPU), or other processors. The touch driving device 350 is coupled to the display panel 340. Based on the control of the processor 310, the touch driving device drives the display panel 340 to detect a touch event, and then reports a detection result of the touch event to the processor 310. This embodiment does not limit the specific implementation of the display panel 340 and the touch driving device 350. For example, the display panel 340 may be a conventional touch display panel or other display panels, and the touch driving device 350 may be a conventional touch driving circuit adapted to the display panel 340 or other touch driving circuits.

Based on the control of the processor 310, the display driving device 320 drives the display panel 340 to display images. The display driving device 320 generates multiple gate clocks GCLK3 to the gate line circuit 330 of the display panel 340. Based on actual design and application, the gate line circuit 330 may include a gate on panel (GOP), a gate on array (Gate on Array, GOA) or other gate line (scan line) scanning circuits. The gate line circuit 330 scans multiple scan lines (not shown) of the display panel 340 based on the triggering of the gate clock GCLK3. Synchronized with a scanning timing of the gate line circuit 330 on the scan lines of the display panel 340, the display driving device 320 outputs a pixel signal Vpixel to the display panel 340 to display an image.

For example, in the embodiment shown in FIG. 3, the display driving device 320 includes a timing controller 321, a source driver 322, and a gate clock generation circuit 323. The source driver 322 and the gate clock generation circuit 323 are coupled to the timing controller 321. The source driver 322 outputs the pixel signal Vpixel based on a pixel data Dpixel of the timing controller 321 to drive multiple data lines (not shown) of the display panel 340. The gate clock generation circuit 323 generates the gate clocks GCLK3 to the gate line circuit 330 of the display panel 340 based on the control of the timing controller 321.

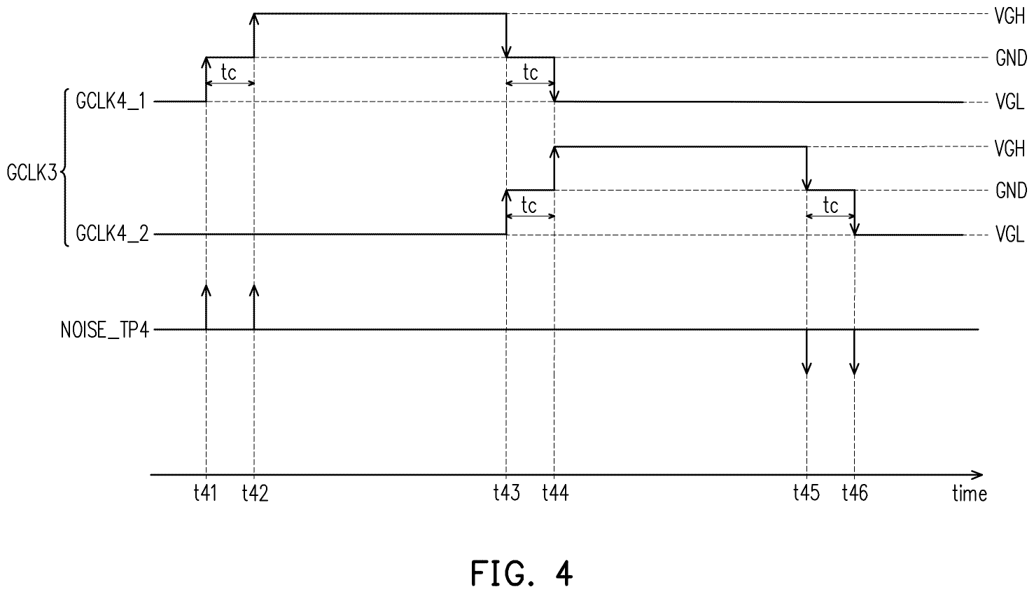

FIG. 4 is a schematic diagram of the waveform of the gate clock GCLK3 when a charge sharing function is enabled during a full frame period according to an embodiment of the disclosure. The horizontal axis of FIG. 4 represents time. Gate clocks GCLK4_1 and GCLK4_2 shown in FIG. 4 may be used as one of many implementation examples of the gate clock GCLK3 shown in FIG. 3. When the charge sharing function is enabled during the full frame period, the gate clock generation circuit 323 pulls up a voltage level of the gate clock GCLK4_1 from a low gate voltage level VGL to a certain charge sharing level (such as a ground voltage level GND) during a charge sharing period tc (time points t41 to t42) first, and then pulls up the voltage level of the gate clock GCLK4_1 from the ground voltage level GND to a high gate voltage level VGH after the charge sharing period te ends. The low gate voltage level VGL and the high gate voltage level VGH may be determined according to the actual design and application. A voltage transition of the gate clock GCLK4_1 at the time points t41 and t42 may cause noise in a touch detection operation of the display panel 340. For example, as shown in FIG. 4, a touch noise NOISE_TP4 has one noise surge at each of the time points t41 and t42. Compared with the case where the charge sharing function is not enabled, the touch noise NOISE_TP4 shown in FIG. 4 causes denser (more) noise surges at the time points t41 and t42 due to the enablement of the charge sharing function. The denser (more) noise surges may prevent a touch detection algorithm from successfully filtering out noise, thereby affecting an accuracy of touch detection.

At time point t43, the voltage level of the gate clock GCLK4_1 is pulled down from the high gate voltage level VGH to the ground voltage level GND, and the voltage level of the gate clock GCLK4_2 is pulled up from the low gate voltage level VGL to the ground voltage level GND. At time point t44, the voltage level of the gate clock GCLK4_1 is pulled down from the ground voltage level GND to the low gate voltage level VGL, and the voltage level of the gate clock GCLK4_2 is pulled up from the ground voltage level GND to the high gate voltage level VGH. Since the voltage transition directions of the gate clocks GCLK4_1 and GCLK4_2 at the time points t43 and t44 are opposite to each other, the touch noise caused by the two may cancel each other out (the noise surge of the touch noise NOISE_TP4 at the time points t43 and t44 is very small or even no noise surge).

The gate clock generation circuit 323 pulls down the voltage level of the gate clock GCLK4_2 from the high gate voltage level VGH to the ground voltage level GND at time point t45 first, and then pulls down the voltage level of the gate clock GCLK4_2 from the ground voltage level GND to the low gate voltage level VGL at time point t46. The voltage transition of gate clock GCLK4_2 at the time points t45 and t46 may cause noise in the touch detection operation of the display panel 340. For example, as shown in FIG. 4, the touch noise NOISE_TP4 has one noise surge at each of the time points t45 and t46. Compared with the case where the charge sharing function is not enabled, the touch noise NOISE_TP4 shown in FIG. 4 causes denser (more) noise surges at the time points t45 and t46 due to the enablement of the charge sharing function. Although the charge sharing function may effectively reduce the power consumption of the display driving device 320, the voltage transitions of the gate clock GCLK4_1 at the time points t41 and t42 and the voltage transitions of the gate clock GCLK4_2 at the time points t45 and t46 may cause denser (more) noise surges of the touch detection operation.

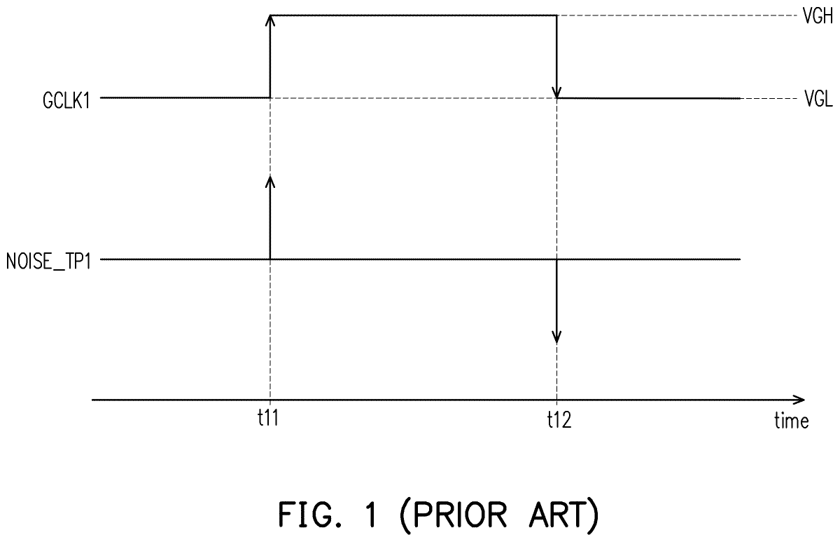

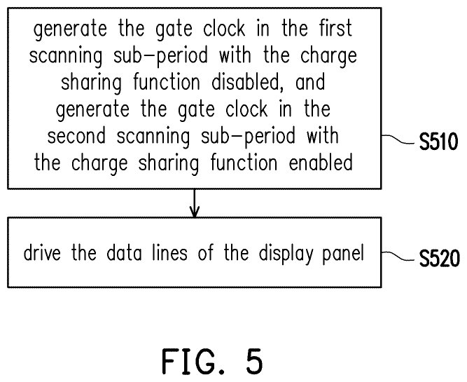

FIG. 5 is a schematic flowchart of an operating method of a display driving device according to an embodiment of the disclosure. Referring to FIG. 3 and FIG. 5, in step S510, the gate clock generation circuit 323 of the display driving device 320 generates the gate clocks GCLK3 to the gate line circuit 330 of the display panel 340. A same frame period includes a first scanning sub-period and a second scanning sub-period. The gate clock generation circuit 323 generates the gate clock GCLK3 in the first scanning sub-period with “the charge sharing function disabled” (for example, the gate clock GCLK1 shown in FIG. 1), and generates the gate clock GCLK3 in the second scanning sub-period with “the charge sharing function enabled” (for example, the gate clocks GCLK4_1 and GCLK4_2 shown in FIG. 4) (step S510). Synchronized with the scanning timing of the gate line circuit 330 on the display panel 340, in step S520, the source driver 322 of the display driving device 320 outputs the pixel signal Vpixel to drive the data lines (not shown) of the display panel 340.

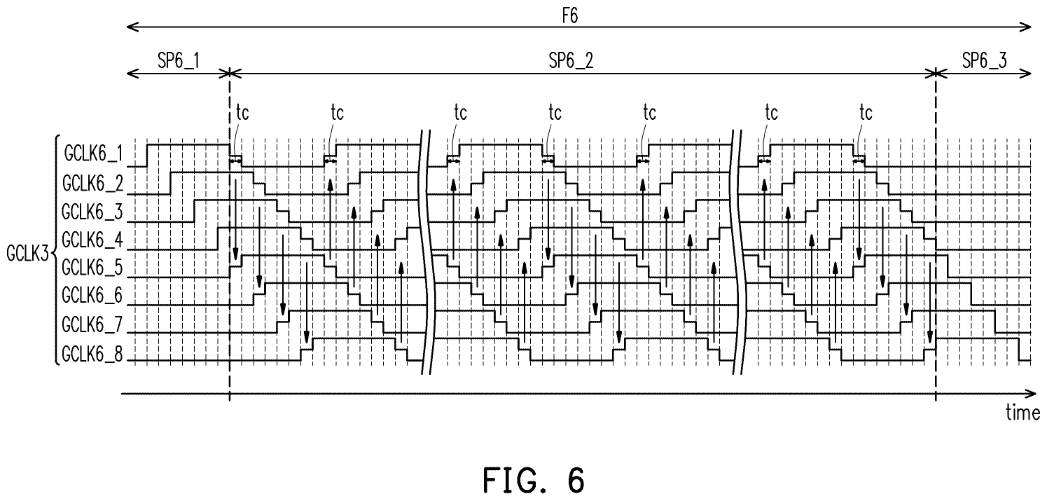

FIG. 6 is a schematic diagram of the waveform of the gate clock GCLK3 when the charge sharing function is dynamically disabled/enabled in different scanning sub-periods of the same frame period according to an embodiment of the disclosure. The horizontal axis of FIG. 6 represents time. In the embodiment shown in FIG. 6, a same frame period F6 includes a scanning sub-period SP6_1, a scanning sub-period SP6_2, and a scanning sub-period SP6_3. The gate clocks GCLK6_1, GCLK6_2, GCLK6_3, GCLK6_4, GCLK6_5, GCLK6_6, GCLK6_7, and GCLK6_8 shown in FIG. 6 may be used as one of many implementation examples of the gate clock GCLK3 shown in FIG. 3. In the scanning sub-periods SP6_1, SP6_2, and SP6_3, the display driving device 320 may generate the gate clocks GCLK6_1 to GCLK6_8 to the gate line circuit 330 of the display panel 340, and the gate line circuit 330 scans the scan lines (not shown) of the display panel 340 based on the triggering of the gate clocks GCLK6_1 to GCLK6_8.

In the scanning sub-period SP6_1 of the frame period F6, when the gate clocks GCLK6_1 to GCLK6_4 undergo the voltage transitions, the gate clocks GCLK6_5 to GCLK6_8 do not undergo the voltage transitions. That is, the voltage transition of the gate clocks GCLK6_1 to GCLK6_4 during the scanning sub-period SP6_1 may cause the touch noise. Therefore, the gate clock generation circuit 323 generates the gate clocks GCLK6_1 to GCLK6_8 in the scanning sub-period SP6_1 with “the charge sharing function disabled”, so as to reduce the number of occurrences of the touch noise. When the charge sharing function is disabled, the display driving device 320 directly transitions each of the target gate clocks among the gate clocks GCLK6_1 to GCLK6_8 from a first voltage level to a second voltage level. For example, the gate clocks GCLK6_1 to GCLK6_4 are directly transitioned from the low gate voltage level VGL to the high gate voltage level VGH.

The gate clock generation circuit 323 generates the gate clocks GCLK6_1 to GCLK6_8 in the scanning sub-period SP6_2 of the frame period F6 with “the charge sharing function enabled”. When the charge sharing function is enabled, the display driving device 320 transitions a target gate clock from the first voltage level to a charge sharing level during the charge sharing period tc first, and then transitions the target gate clock from the charge sharing level to the second voltage level after the charge sharing period tc ends. For example, the display driving device 320 pulls up the gate clock GCLK6_1 from the low gate voltage level VGL to the charge sharing level (such as the ground voltage level GND) during the charge sharing period te, and pulls down the gate clock GCLK6_5 from the high gate voltage level VGL to the charge sharing level (such as the ground voltage level GND); at the same time point after the charge sharing period tc ends, the display driving device 320 pulls up the gate clock GCLK6_1 from the charge sharing level to the high gate voltage level VGH, and pulls down the gate clock GCLK6_5 from the charge sharing level to the low gate voltage level VGL.

In the scanning sub-period SP6_2, the gate clocks GCLK6_1 and GCLK6_5 are mutually inverse. The gate clocks GCLK6_2 and GCLK6_6 are mutually inverse. The gate clocks GCLK6_3 and GCLK6_7 are mutually inverse. The gate clocks GCLK6_4 and GCLK6_8 are mutually inverse. The so-called mutually inverse means that a voltage transition time point of the gate clock is approximately the same and the voltage transition direction of the gate clock is opposite. Since the gate clocks GCLK6_1 to GCLK6_8 are mutually inverse during the scanning sub-period SP6_2, the touch noise caused by the gate clocks GCLK6_1 to GCLK6_8 may cancel each other out. Therefore, the gate clock generation circuit 323 may enable the charge sharing function in the scanning sub-period SP6_2 to reduce the power consumption of the gate clock generation circuit 323.

In the scanning sub-period SP6_3 of the frame period F6, when the gate clocks GCLK6_5 to GCLK6_8 undergo the voltage transitions, the gate clocks GCLK6_1 to GCLK6_4 do not undergo the voltage transitions. That is, the voltage transition of the gate clocks GCLK6_5 to GCLK6_8 during the scanning sub-period SP6_3 may cause the touch noise. Therefore, the gate clock generation circuit 323 generates the gate clocks GCLK6_1 to GCLK6_8 in the scanning sub-period SP6_3 with “the charge sharing function disabled”, so as to reduce the number of occurrences of the touch noise. When the charge sharing function is disabled, the display driving device 320 directly transitions each of the target gate clocks among the gate clocks GCLK6_1 to GCLK6_8 from the second voltage level to the first voltage level. For example, GCLK6_5 to GCLK6_8 are directly transitioned from the high gate voltage level VGH to the low gate voltage level VGL.

To sum up, the gate clock generation circuit 323 dynamically disables and enables the charge sharing function in the different scanning sub-periods SP6_1, SP6_2, and SP6_3 of the same frame period F6. During the scanning sub-periods SP6_1 and SP6_3, the touch noises caused by the gate clocks GCLK6_1 to GCLK6_8 do not cancel each other, so the gate clock generation circuit 323 disables the charge sharing function during the scanning sub-periods SP6_1 and SP6_3 to reduce the number of noise surges of the touch noise to avoid affecting the accuracy of the touch detection. During the scanning sub-period SP6_2, since the gate clocks GCLK6_1 to GCLK6_8 are mutually inverse, the touch noise caused by the gate clocks GCLK6_1 to GCLK6_8 may cancel each other out. Therefore, the gate clock generation circuit 323 may enable the charge sharing function during the scanning sub-period SP6_2 to reduce the power consumption.

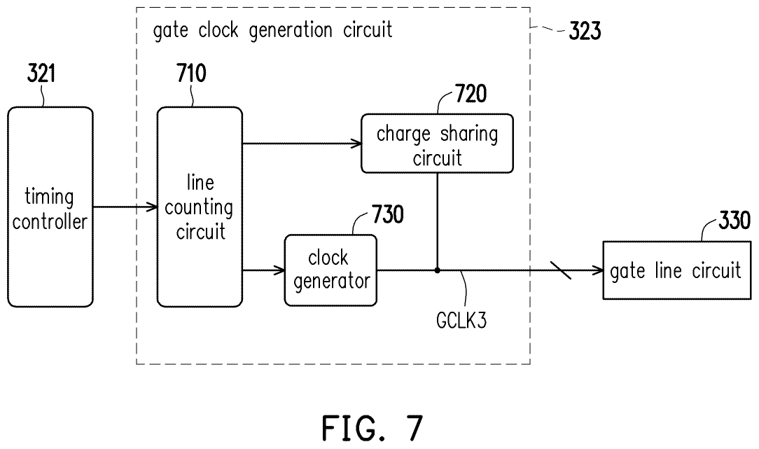

FIG. 7 is a circuit block diagram of a gate clock generation circuit 323 according to an embodiment of the disclosure. The gate clock generation circuit 323 shown in FIG. 7 may be used as one of many implementation examples of the gate clock generation circuit 323 shown in FIG. 3. The timing controller 321, the gate clock generation circuit 323, and the gate line circuit 330 shown in FIG. 7 may refer to the relevant description of FIG. 3, so the details are not repeated herein. In the embodiment shown in FIG. 7, the gate clock generation circuit 323 includes a line counting circuit 710, a charge sharing circuit 720, and a clock generator 730. The line counting circuit 710 counts currently driven scan lines in the same frame period using a scan line count value. That is, the line counting circuit 710 may know which scan line of the display panel 340 the gate line circuit 330 currently scans to based on the scan line count value. The clock generator 730 is coupled to the line counting circuit 710. The line counting circuit 710 controls the clock generator 730 to generate the gate clock GCLK3 based on the scan line count value. The clock generator 730 outputs the gate clocks GCLK3 to the gate line circuit 330 of the display panel 340 through multiple gate clock transmission lines.

The charge sharing circuit 720 is coupled to the gate clock transmission line between the line counting circuit 710 and the gate line circuit 330. The line counting circuit 710 controls the charge sharing circuit 720 based on the scan line count value. For example, referring to FIG. 6 and FIG. 7, the line counting circuit 710 disables the charge sharing circuit 720 in the scanning sub-period SP6_1 of the frame period F6 to disable the charge sharing function for the gate clock transmission lines. The line counting circuit 710 enables the charge sharing circuit 720 in the scanning sub-period SP6_2 of the same frame period F6 to enable the charge sharing function for the gate clock transmission lines. The line counting circuit 710 disables the charge sharing circuit 720 again in the scanning sub-period SP6_3 of the same frame period F6 to disable the charge sharing function for the gate clock transmission lines.

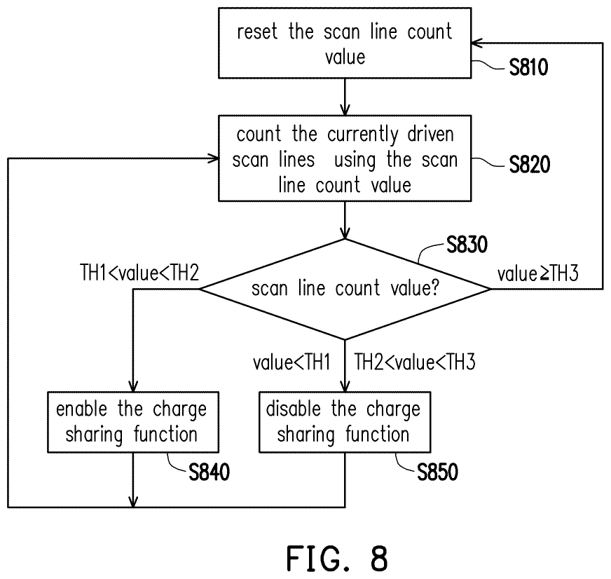

FIG. 8 is a schematic flowchart of an operating method of a display driving device according to another embodiment of the disclosure. Referring to FIG. 7 and FIG. 8, in step S810, the line counting circuit 710 resets the scan line count value. In step S820, the line counting circuit 710 counts the currently driven scan lines in the same frame period using the scan line count value. In step S830, the line counting circuit 710 checks the scan line count value. When the scan line count value is less than a threshold TH1 (a judgment result in step S830 is “value<TH1”, which is in the scanning sub-period SP6_1 of the same frame period F6), the line counting circuit 710 disables the charge sharing circuit 720 to disable the charge sharing function (step 850). The threshold TH1 may be determined according to the actual design or application. After the step S850, the line counting circuit 710 returns to the step S820 to continue counting the currently driven scan lines.

When the scan line count value is greater than the threshold value TH1 and the scan line count value is less than a threshold value TH2 (the judgment result in step S830 is “TH1<value <TH2”, which is in the scanning sub-period SP6_2 of the same frame period F6), the line counting circuit 710 enables the charge sharing circuit 720 to enable the charge sharing function (step 840). The threshold TH2 may be determined according to actual design or application, and the threshold TH2 is greater than the threshold TH1. After the step S840, the line counting circuit 710 returns to the step S820 to continue counting the currently driven scan lines.

When the scan line count value is greater than the threshold value TH2 and the scan line count value is less than a threshold value TH3 (the judgment result in step S830 is “TH2<value <TH3”, which is in the scanning sub-period SP6_3 of the same frame period F6), the line counting circuit 710 disables the charge sharing circuit 720 again to disable the charge sharing function (step 850). The threshold TH3 may be determined according to actual design or application, and the threshold TH3 is greater than the threshold TH2. After the step S850, the line counting circuit 710 returns to the step S820 to continue counting the currently driven scan lines. In response to the scan line count value being equal to or greater than the threshold TH3 (the judgment result of the step S830 is “value>TH3”, which is after the scanning sub-period SP6_3 of the frame period F6 ends), the line counting circuit 710 returns to the step S810 to reset the scan line count value (preparing to enter a new frame period).

According to different designs, in some embodiments, the display driving device 320, the timing controller 321, the source driver 322, the gate clock generation circuit 323, the line counting circuit 710, the charge sharing circuit 720, the clock generator 730, and (Or) the touch driving device 350 may be implemented as a hardware circuit. In other embodiments, the display driving device 320, the timing controller 321, the source driver 322, the gate clock generation circuit 323, the line counting circuit 710, the charge sharing circuit 720, the clock generator 730, and/or the touch driving device 350 may be implemented as hardware, firmware, software (i.e., program), or a combination of the above.

In terms of hardware form, the display driving device 320, the timing controller 321, the source driver 322, the gate clock generation circuit 323, the line counting circuit 710, the charge sharing circuit 720, the clock generator 730, and/or the touch driving device 350 may be implemented as a logic circuit on an integrated circuit. For example, related functions of the display driving device 320, the timing controller 321, the source driver 322, the gate clock generation circuit 323, the line counting circuit 710, the charge sharing circuit 720, the clock generator 730, and/or the touch driving device 350 may be implemented in one or more hardware controllers, microcontrollers, hardware processors, microprocessors, application-specific integrated circuits (ASIC), digital signal processor (DSP), field programmable gate array (FPGA), CPU, and/or various types of logic blocks, modules, and circuits in other processing units. The related functions of the display driving device 320, the timing controller 321, the source driver 322, the gate clock generation circuit 323, the line counting circuit 710, the charge sharing circuit 720, the clock generator 730, and/or the touch driving device 350 may be implemented as hardware circuits, such as various logic blocks, modules, and circuits in the integrated circuit, using hardware description languages (such as Verilog HDL or VHDL) or other suitable programming languages.

In terms of software form and/or firmware form, the related functions of the display driving device 320, the timing controller 321, the source driver 322, the gate clock generation circuit 323, the line counting circuit 710, the charge sharing circuit 720, the clock generator 730, and/or the touch driving device 350 may be implemented as programming codes. For example, general programming languages (such as C, C++, or combinatorial language) or other suitable programming languages are used to implement the display driving device 320, the timing controller 321, the source driver 322, the gate clock generation circuit 323, and the line counting circuit 710, the charge sharing circuit 720, the clock generator 730, and/or the touch driving device 350. The programming code may be recorded/stored in a “non-transitory machine-readable storage medium” or a computer program product. In some embodiments, the non-transitory machine-readable storage medium or the computer program product includes, for example, a semiconductor memory and/or a storage device. The electronic device (such as the computer, the CPU, the hardware controller, the microcontroller, the hardware processor, or the microprocessor) may read and execute the programming code from the non-transitory machine-readable storage medium or the computer program product, thereby realizing the related functions of the display driving device 320, the timing controller 321, the source driver 322, the gate clock generation circuit 323, the line counting circuit 710, the charge sharing circuit 720, the clock generator 730, and/or the touch driving device 350. Alternatively, the programming code or the computer program product may be provided to the electronic device via any transmission media (such as a communication network or a broadcast wave, etc.). The communication network is, for example, the Internet, a wired communication network, a wireless communication network or other communication media.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

1. A display apparatus comprising:
a display panel;
a touch driving device coupled to the display panel, wherein the touch driving device drives the display panel to detect a touch event; and
a display driving device configured to drive the display panel, wherein the display driving device generates a plurality of gate clocks to a gate line circuit of the display panel, the gate line circuit scans a plurality of scan lines of the display panel based on the plurality of gate clocks, a same frame period comprises a first scanning sub-period and a second scanning sub-period,
the display driving device generates the plurality of gate clocks in the first scanning sub-period of the same frame period with a charge sharing function disabled and directly transitions a target gate clock among the plurality of gate clocks from a first voltage level to a second voltage level, and
the display driving device generates the plurality of gate clocks in the second scanning sub-period of the same frame period with the charge sharing function enabled and transitions the target gate clock from the first voltage level to a charge sharing level during a charge sharing period first, and then transitions the target gate clock from the charge sharing level to the second voltage level after the charge sharing period ends.

2. (canceled)

3. The display apparatus according to claim 1, wherein the charge sharing level is a ground voltage level.

4. The display apparatus according to claim 1, wherein in response to the charge sharing function being enabled,
during a charge sharing period, the display driving device pulls up a first gate clock among the plurality of gate clocks from a low gate voltage level to a charge sharing level, and pulls down a second gate clock among the plurality of gate clocks from a high gate voltage level to the charge sharing level; and
at a same time point after the charge sharing period ends, the display driving device pulls up the first gate clock from the charge sharing level to the high gate voltage level, and pulls down the second gate clock from the charge sharing level to the low gate voltage level.

5. The display apparatus according to claim 1, wherein the same frame period further comprises a third scanning sub-period, the second scanning sub-period is located between the first scanning sub-period and the third scanning sub-period, and the display driving device generates the plurality of gate clocks in the third scanning sub-period of the same frame period with the charge sharing function disabled.

6. The display apparatus according to claim 1, wherein the display driving device comprises:
a timing controller;
a source driver coupled to the timing controller, wherein the source driver drives a plurality of data lines of the display panel based on the control of the timing controller; and
a gate clock generation circuit coupled to the timing controller, wherein the gate clock generation circuit generates the plurality of gate clocks to the gate line circuit based on the control of the timing controller,
the gate clock generation circuit generates the plurality of gate clocks in the first scanning sub-period of the same frame period with the charge sharing function disabled, and
the gate clock generation circuit generates the plurality of gate clocks in the second scanning sub-period of the same frame period with the charge sharing function enabled.

7. The display apparatus according to claim 6, wherein the gate clock generation circuit comprises:
a line counting circuit, wherein the line counting circuit counts currently driven scan lines in the same frame period with a scan line count value;
a clock generator coupled to the line counting circuit, wherein the line counting circuit controls the clock generator to generate the plurality of gate clocks based on the scan line count value, and the clock generator outputs the plurality of gate clocks to the gate line circuit through a plurality of gate clock transmission lines; and
a charge sharing circuit coupled to the plurality of gate clock transmission lines, wherein the line counting circuit controls the charge sharing circuit based on the scan line count value, the charge sharing circuit is disabled in the first scanning sub-period of the same frame period to disable the charge sharing function for the plurality of gate clock transmission lines, and the charge sharing circuit is enabled in the second scanning sub-period of the same frame period to enable the charge sharing function for the plurality of gate clock transmission lines.

8. The display apparatus according to claim 7, wherein,
in response to the scan line count value being less than a first threshold, the line counting circuit disables the charge sharing circuit; and
in response to the scan line count value being greater than the first threshold and less than a second threshold, the line counting circuit enables the charge sharing circuit.

9. The display apparatus according to claim 8, wherein,
in response to the scan line count value being greater than the second threshold and less than a third threshold, the line counting circuit disables the charge sharing circuit; and
in response to the scan line count value being equal to or greater than the third threshold, the line counting circuit resets the scan line count value.

10. A display driving device configured to drive a display panel, wherein the display driving device comprises:
a timing controller;
a source driver coupled to the timing controller, wherein the source driver drives a plurality of data lines of the display panel based on the control of the timing controller; and
a gate clock generation circuit coupled to the timing controller, wherein the gate clock generation circuit generates a plurality of gate clocks to a gate line circuit of the display panel based on the control of the timing controller, the gate line circuit scans a plurality of scan lines of the display panel based on the plurality of gate clocks, a same frame period comprises a first scanning sub-period and a second scanning sub-period,
the gate clock generation circuit generates the plurality of gate clocks in the first scanning sub-period of the same frame period with a charge sharing function disabled and directly transitions a target gate clock among the plurality of gate clocks from a first voltage level to a second voltage level, and
the gate clock generation circuit generates the plurality of gate clocks in the second scanning sub-period of the same frame period with the charge sharing function enabled and transitions the target gate clock from the first voltage level to a charge sharing level during a charge sharing period first, and then transitions the target gate clock from the charge sharing level to the second voltage level after the charge sharing period ends.

11. (canceled)

12. The display driving device according to claim 10, wherein the charge sharing level is a ground voltage level.

13. The display driving device according to claim 10, wherein in response to the charge sharing function being enabled,
during a charge sharing period, the display driving device pulls up a first gate clock among the plurality of gate clocks from a low gate voltage level to a charge sharing level, and pulls down a second gate clock among the plurality of gate clocks from a high gate voltage level to the charge sharing level; and
at a same time point after the charge sharing period ends, the display driving device pulls up the first gate clock from the charge sharing level to the high gate voltage level, and pulls down the second gate clock from the charge sharing level to the low gate voltage level.

14. The display driving device according to claim 10, wherein the same frame period further comprises a third scanning sub-period, the second scanning sub-period is located between the first scanning sub-period and the third scanning sub-period, and the gate clock generation circuit generates the plurality of gate clocks in the third scanning sub-period of the same frame with the charge sharing function disabled.

15. The display driving device of claim 10, wherein the gate clock generation circuit comprises:
a line counting circuit, wherein the line counting circuit counts currently driven scan lines in the same frame period with a scan line count value;
a clock generator coupled to the line counting circuit, wherein the line counting circuit controls the clock generator to generate the plurality of gate clocks based on the scan line count value, and the clock generator outputs the plurality of gate clocks to the gate line circuit through a plurality of gate clock transmission lines; and
a charge sharing circuit coupled to the plurality of gate clock transmission lines, wherein the line counting circuit controls the charge sharing circuit based on the scan line count value, the charge sharing circuit is disabled in the first scanning sub-period of the same frame period to disable the charge sharing function for the plurality of gate clock transmission lines, and the charge sharing circuit is enabled in the second scanning sub-period of the same frame period to enable the charge sharing function for the plurality of gate clock transmission lines.

16. The display driving device according to claim 15, wherein,
in response to the scan line count value being less than a first threshold, the line counting circuit disables the charge sharing circuit; and
in response to the scan line count value being greater than the first threshold and less than a second threshold, the line counting circuit enables the charge sharing circuit.

17. The display driving device according to claim 16, wherein,
in response to the scan line count value being greater than the second threshold and less than a third threshold, the line counting circuit disables the charge sharing circuit; and
in response to the scan line count value being equal to or greater than the third threshold, the line counting circuit resets the scan line count value.

18. An operating method of a display driving device comprising:
driving a plurality of data lines of a display panel by a source driver of the display driving device; and
generating a plurality of gate clocks to a gate line circuit of the display panel by a gate clock generation circuit of the display driving device, wherein the gate line circuit scans a plurality of scan lines of the display panel based on the plurality of gate clocks, a same frame period comprises a first scanning sub-period and a second scanning sub-period, the gate clock generation circuit generates the plurality of gate clocks in the first scanning sub-period of the same frame period with a charge sharing function disabled and directly transitions a target gate clock among the plurality of gate clocks from a first voltage level to a second voltage level, and the gate clock generation circuit generates the plurality of gate clocks in the second scanning sub-period of the same frame period with the charge sharing function enabled and transitions the target gate clock from the first voltage level to a charge sharing level during a charge sharing period first, and then transitions the target gate clock from the charge sharing level to the second voltage level after the charge sharing period ends.

19. (canceled)

20. The operating method according to claim 18, wherein the charge sharing level is a ground voltage level.

21. The operating method according to claim 18 further comprising:
in response to the charge sharing function being enabled, during a charge sharing period, pulling up a first gate clock among the plurality of gate clocks from a low gate voltage level to a charge sharing level, and pulling down a second gate clock among the plurality of gate clocks from a high gate voltage level to the charge sharing level; and
in response to the charge sharing function being enabled, at a same time point after the charge sharing period ends, pulling up the first gate clock from the charge sharing level to the high gate voltage level, and pulling down the second gate clock from the charge sharing level to the low gate voltage level.

22. The operating method according to claim 18, wherein the same frame period further comprises a third scanning sub-period, the second scanning sub-period is located between the first scanning sub-period and the third scanning sub-period, and the operating method further comprises:
generating the plurality of gate clocks by the gate clock generation circuit in the third scanning sub-period of the same frame period with the charge sharing function disabled.

23. The operating method according to claim 18 further comprising:
counting currently driven scan lines in the same frame period with a scan line count value by a line counting circuit of the gate clock generation circuit;
controlling a clock generator of the gate clock generation circuit to generate the plurality of gate clocks based on the scan line count value by the line counting circuit;
outputting the plurality of gate clocks to the gate line circuit through a plurality of gate clock transmission lines by the clock generator; and
controlling a charge sharing circuit of the gate clock generation circuit based on the scan line count value by the line counting circuit, wherein the charge sharing circuit is disabled in the first scanning sub-period of the same frame period to disable the charge sharing function for the plurality of gate clock transmission lines, and the charge sharing circuit is enabled in the second scanning sub-period of the same frame period to enable the charge sharing function for the plurality of gate clock transmission lines.

24. The operating method according to claim 23 further comprising:
disabling the charge sharing circuit in response to the scan line count value being less than a first threshold; and
enabling the charge sharing circuit in response to the scan line count value being greater than the first threshold and less than a second threshold.

25. The operating method according to claim 24 further comprising:
disabling the charge sharing circuit in response to the scan line count value being greater than the second threshold and less than a third threshold; and
resetting the scan line count value in response to the scan line count value being equal to or greater than the third threshold.
